(19) United States
(12) Patent Application Publication
(10) Pub. No.: US 2024/0051425 A1
(43) Pub. Date: Feb. 15, 2024

(54) SYSTEM AND METHOD FOR CONTROLLING CHARGING OF VEHICLE

(71) Applicants: Hyundai Motor Company, Seoul (KR); Kia Corporation, Seoul (KR)

(72) Inventor: Han Shik KIM, Seoul (KR)

(73) Assignees: Hyundai Motor Company, Seoul (KR); Kia Corporation, Seoul (KR)

(21) Appl. No.: 18/122,570

(22) Filed: Mar. 16, 2023

(30) Foreign Application Priority Data
Aug. 9, 2022 (KR) 10-2022-0099320

(51) Int. Cl. B60L 53/68; G05B 19/042

(52) U.S. Cl. CPC B60L 53/68; G05B 19/042; G05B 2219/2639

(57) ABSTRACT

A system for controlling charging of a vehicle includes the vehicle that determines whether a distance to empty has changed based on the charging, and transmits a charging station failure report message upon concluding that there is no change in the distance to empty, and a server that receives the charging station failure report message, changes state information of a charging station where a failure has been reported, and informs that the charging station where the failure has been reported is unavailable.

### CROSS-REFERENCE TO RELATED APPLICATION

The present application claims priority to Korean Patent Application No. 10-2022-0099320, filed on Aug. 9, 2022, the entire contents of which is incorporated herein for all purposes by this reference.

### BACKGROUND OF THE PRESENT DISCLOSURE

### Field of the Present Disclosure

The present disclosure relates to a system and a method for controlling charging of a vehicle.

### Description of Related Art

Recently, as a spread of eco-friendly vehicles including an electric vehicle, a hydrogen vehicle, and the like is expanding, a technology for providing charging station information to the eco-friendly vehicles is being developed.

The charging station information may include information of a charging station location, a charging station state, and the like. It is common for charging station installers to provide the charging station information, but the reality is that real-time charging station information is not able to be provided because of a cost limitation.

Therefore, when the vehicle receives the charging station information that has not been updated in real-time in a state in which a distance to empty (DTE) is not much left, smooth charging may be difficult. Furthermore, when a situation in which the vehicle is not able to travel occurs, discomfort of a user is increased.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system and a method for controlling charging of a vehicle which may provide stable charging station information to a user by updating the charging station information in real-time.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a system for controlling charging of a vehicle includes the vehicle that determines whether a distance to empty has changed based on the charging, and transmits a charging station failure report message upon concluding that there is no change in the distance to empty, and a server that receives the charging station failure report message, changes state information of a charging station where a failure has been reported, and informs that the charging station where the failure has been reported is unavailable.

In an exemplary embodiment of the present disclosure, the server may change the state information of the charging station where the failure has been reported when the charging station failure report message is received a predetermined number of times or more than the predetermined number of times.

In an exemplary embodiment of the present disclosure, the server may change the state information of the charging station where the failure has been reported from an available state to an unavailable state when the charging station failure report message is received.

In an exemplary embodiment of the present disclosure, the server may inform that the charging station where the failure has been reported is unavailable.

In an exemplary embodiment of the present disclosure, the system may further include a portable terminal for transmitting the charging station failure report message to the server when a user input related to the charging station failure is received.

In an exemplary embodiment of the present disclosure, the vehicle may transmit charging station information to the server when there is the change in the distance to empty based on the charging.

In an exemplary embodiment of the present disclosure, the server may determine whether a charging station where the vehicle has been charged is the charging station where the failure has been reported based on the received charging station information.

In an exemplary embodiment of the present disclosure, the server may change a state of the charging station where the failure has been reported from an unavailable state to an available state when concluding that the charging station where the vehicle has been charged is the charging station where the failure has been reported.

In an exemplary embodiment of the present disclosure, the server may inform that the charging station where the failure has been reported is available when a state of the charging station where the failure has been reported is changed from an unavailable state to an available state.

According to another aspect of the present disclosure, a method for controlling charging of a vehicle includes determining whether a distance to empty has changed based on the charging, transmitting a charging station failure report message to a server when there is no change in the distance to empty, receiving the charging station failure report message, and changing state information of a charging station where a failure has been reported, and informing that the charging station where the failure has been reported is unavailable.

In an exemplary embodiment of the present disclosure, the method may further include changing the state information of the charging station where the failure has been reported when the charging station failure report message is received a predetermined number of times or more than the predetermined number of times.

In an exemplary embodiment of the present disclosure, the method may further include changing the state information of the charging station where the failure has been reported from an available state to an unavailable state when the charging station failure report message is received.

In an exemplary embodiment of the present disclosure, the method may further include informing that the charging station where the failure has been reported is unavailable.

In an exemplary embodiment of the present disclosure, the method may further include receiving the charging station failure report message from a portable terminal.

In an exemplary embodiment of the present disclosure, the method may further include transmitting charging station information to the server when there is the change in the distance to empty based on the charging.

In an exemplary embodiment of the present disclosure, the method may further include determining whether a charging station where the vehicle has been charged is the charging station where the failure has been reported based on the received charging station information.

In an exemplary embodiment of the present disclosure, the method may further include changing a state of the charging station where the failure has been reported from an unavailable state to an available state when concluding that the charging station where the vehicle has been charged is the charging station where the failure has been reported.

In an exemplary embodiment of the present disclosure, the method may further include informing that the charging station where the failure has been reported is available when a state of the charging station where the failure has been reported is changed from an unavailable state to an available state.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a configuration of a vehicle charging control system according to an exemplary embodiment of the present disclosure;

FIG. 2 is a view exemplarily illustrating a configuration of a vehicle according to an exemplary embodiment of the present disclosure;

FIG. 3 is a view exemplarily illustrating a configuration of a server according to an exemplary embodiment of the present disclosure;

FIG. 4 is a view exemplarily illustrating a configuration of a portable terminal according to an exemplary embodiment of the present disclosure;

FIG. 5 and FIG. 6 are views exemplarily illustrating a vehicle charging control method according to an exemplary embodiment of the present disclosure; and

FIG. 7 is a view exemplarily illustrating a configuration of a computing system executing a method according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure.

In describing the components of the exemplary embodiment of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as including a meaning which is consistent with their meaning in the context of the relevant art and will not be interpreted in an idealized or overly formal sense unless so defined herein.

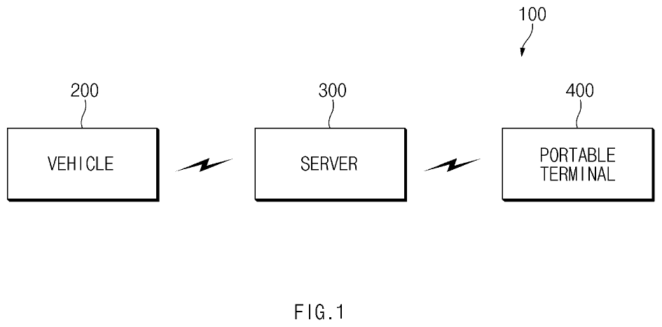

FIG. 1 is a view exemplarily illustrating a configuration of a vehicle charging control system according to an exemplary embodiment of the present disclosure.

As shown in FIG. 1, a vehicle charging control system 100 according to an exemplary embodiment of the present disclosure may include a vehicle 200, a server 300, and a portable terminal 400.

The vehicle 200 may determine whether a distance to empty (DTE) has changed based on charging, and when there is no change in the distance to empty, transmit a charging station failure report message to the server 300. Furthermore, when there is the change in the distance to empty based on the charging, the vehicle 200 may transmit information of a charging station where the vehicle has been charged to the server 300. In this regard, the charging station information may include a charging station name, a charging station location, and the like. In an exemplary embodiment of the present disclosure, the vehicle 200 may include a plurality of vehicles in communication with the server 300. According to an exemplary embodiment of the present disclosure, the vehicle 200 may include a first vehicle 200-1, a second vehicle 200-2, . . . , and an n-th vehicle 200-n.

When receiving the charging station failure report message from the vehicle, the server 300 may change a state information of a charging station where a failure has been reported, and may inform that the charging station where the failure has been reported is unavailable.

When receiving a user input related to the charging station failure, the portable terminal 400 may transmit the charging station failure report message to the server 300.

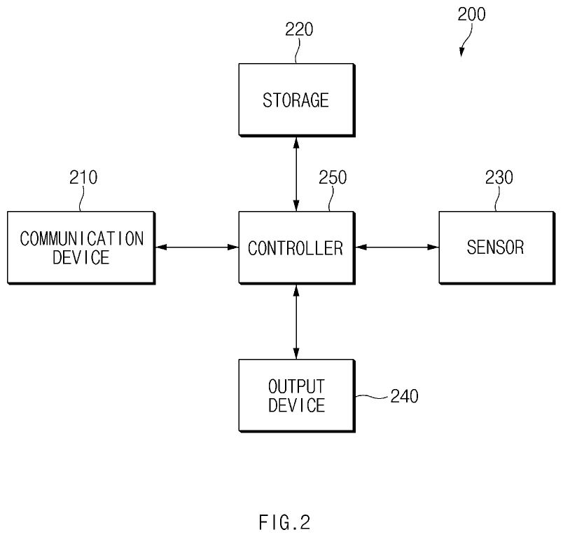

FIG. 2 is a view exemplarily illustrating a configuration of a vehicle according to an exemplary embodiment of the present disclosure.

As shown in FIG. 2, the vehicle 200 may include a communication device 210, storage 220, a sensor 230, an output device 240, and a controller 250.

The communication device 210 may communicate with the server 300 in various wireless communication schemes, such as a Wi-Fi, a WiBro, a Global System for Mobile communication (GSM), a Code Division Multiple Access (CDMA), a Wideband Code Division Multiple Access (WCDMA), a Universal Mobile Telecommunication System (UMTS), a Time Division Multiple Access (TDMA), a Long Term Evolution (LTE), and the like.

The storage 220 may store at least one algorithm for performing operation or execution of various commands for an operation of the vehicle according to an exemplary embodiment of the present disclosure. The storage 220 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The sensor 230 may detect a state of the vehicle. According to an exemplary embodiment of the present disclosure, the sensor 230 may include a battery sensor or a fuel sensor, and may detect a battery residual amount or a fuel residual amount of the vehicle.

The output device 240 may output the information received from the server 300 in at least one of a visual scheme and an auditory scheme to a user. To the present end, the output device 240 may include a display device that outputs an image or a video, and the display device may include a display device of a navigation system, a HUD, a cluster, and the like. Furthermore, the output device 240 may include a sound output device configured for outputting a sound, and the sound output device may include a speaker.

The controller 250 may be implemented by various processing devices, such as a microprocessor with a built-in semiconductor chip configured for performing the operation or the execution of the various commands, and may control the operation of the vehicle according to an exemplary embodiment of the present disclosure.

The controller 250 may determine the distance to empty (DTE) based on the battery residual amount or the fuel residual amount. The controller 250 may determine whether the distance to empty of the vehicle has changed when the charging is performed.

When determining that the distance to empty has not changed after the charging is performed, the controller 250 may determine that the charging is unavailable at the charging station. When determining that the charging is unavailable at the charging station, the controller 250 may transmit the charging station failure report message to the server 300.

On the other hand, when determining that the distance to empty has changed after the charging is performed, the controller 250 may transmit the charging station information to the server 300.

When being informed, from the server 300, that the charging station is unavailable or that the charging station is available, the controller 250 may output the received information via the output device 240. Furthermore, the controller 250 may receive the information from the server 300 in real-time to update a route to a destination.

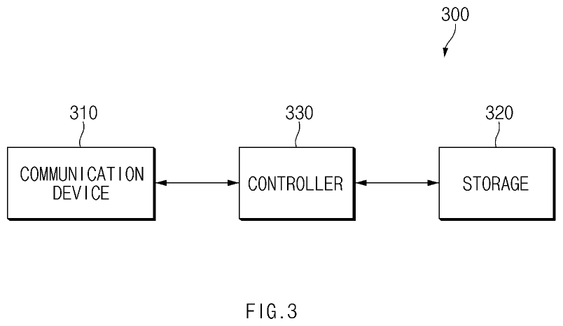

FIG. 3 is a view exemplarily illustrating a configuration of a server according to an exemplary embodiment of the present disclosure.

As shown in FIG. 3, the server 300 may include a communication device 310, storage 320, and a controller 330.

The communication device 310 may communicate with the vehicle 200 and the portable terminal 400 in various wireless communication schemes, such as a Wi-Fi, a WiBro, a Global System for Mobile communication (GSM), a Code Division Multiple Access (CDMA), a Wideband Code Division Multiple Access (WCDMA), a Universal Mobile Telecommunication System (UMTS), a Time Division Multiple Access (TDMA), a Long Term Evolution (LTE), and the like.

The storage 320 may store at least one algorithm for performing operation or execution of various commands for an operation of the server according to an exemplary embodiment of the present disclosure. The storage 320 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The controller 330 may be implemented by various processing devices, such as a microprocessor with a built-in semiconductor chip configured for performing the operation or the execution of the various commands, and may control the operation of the server according to an exemplary embodiment of the present disclosure.

When receiving the charging station failure report message from the vehicle 200 or the portable terminal 400, the controller 330 may determine whether the charging station failure report message has been received for the same charging station a predetermined number of times or more than the predetermined number of times. In this regard, the predetermined number of times may be set based on the number of vehicles in communication with the server (300). For example, when the number of vehicles in communication with the server 300 is great, the predetermined number of times may be increased, and when the number of vehicles in communication with the server 300 is small, the predetermined number of times may be decreased.

When determining that the charging station failure report message has been received the predetermined number of times or more than the predetermined number of times, the controller 330 may determine that a plurality of vehicles of the number corresponding to the predetermined number of times have determined that the charging is unavailable at the same charging station, and may change the state information of the charging station where the failure has been reported.

According to an exemplary embodiment of the present disclosure, when determining that the charging station failure report message has been received the predetermined number of times or more than the predetermined number of times, the controller 330 may change the state information of the charging station where the failure has been reported from an available state to an unavailable state.

When the state information of the charging station where the failure has been reported changes from the available state to the unavailable state, the controller 330 may inform that the charging station where the failure has been reported is unavailable. According to an exemplary embodiment of the present disclosure, the controller 330 may inform other vehicles and other portable terminals except for the vehicle that has transmitted the charging station failure report message and the portable terminal 400 that has transmitted the charging station failure report message that the charging station where the failure has been reported is unavailable.

In one example, the controller 330 may receive the charging station information from the vehicle 200 or the portable terminal 400. When receiving the charging station information from the vehicle 200 or the portable terminal 400, the controller 330 may determine whether the charging station where the vehicle has been charged is the charging station where the failure has been reported based on the received charging station information.

When determining based on the charging station information received from the vehicle 200 that the charging station where the vehicle has been charged is the charging station where the failure has been reported, the controller 330 may change the state information of the charging station where the failure has been reported.

According to an exemplary embodiment of the present disclosure, when determining based on the charging station information received from the vehicle 200 that the charging station where the vehicle has been charged is the charging station where the failure has been reported, the controller 330 may change the state information of the charging station where the failure has been reported from the unavailable state to the available state.

When the state information of the charging station where the failure has been reported changes from the unavailable state to the available state, the controller 330 may inform that the charging station where the failure has been reported is available. According to an exemplary embodiment of the present disclosure, the controller 330 may inform other vehicles and other portable terminals except for the vehicle that has transmitted the charging station information and the portable terminal 400 that has transmitted the charging station information that the charging station where the failure has been reported is available.

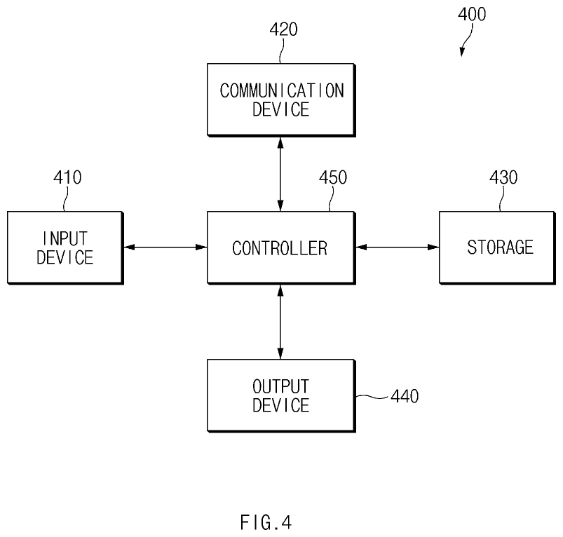

FIG. 4 is a view exemplarily illustrating a configuration of a portable terminal according to an exemplary embodiment of the present disclosure.

As shown in FIG. 4, the portable terminal 400 may include an input device 410, a communication device 420, storage 430, an output device 440, and a controller 450.

The input device 410 may receive an input corresponding to a touch, a motion, or a voice of the user, and transmit the input to the controller 450. According to an exemplary embodiment of the present disclosure, the input device 410 may receive the charging station failure report message, and may receive the charging station information.

The communication device 420 may communicate with the server 300 in various wireless communication schemes, such as a Wi-Fi, a WiBro, a Global System for Mobile communication (GSM), a Code Division Multiple Access (CDMA), a Wideband Code Division Multiple Access (WCDMA), a Universal Mobile Telecommunication System (UMTS), a Time Division Multiple Access (TDMA), a Long Term Evolution (LTE), and the like.

The storage 430 may store at least one algorithm for performing operation or execution of various commands for an operation of the portable terminal according to an exemplary embodiment of the present disclosure. The storage 430 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The output device 440 may output the information received from the server 300 in at least one of a visual scheme and an auditory scheme to the user. To the present end, the output device 440 may include a display device that outputs an image or a video. According to an exemplary embodiment of the present disclosure, the display device may be formed integrally with the input device 410. Furthermore, the output device 440 may include a sound output device configured for outputting a sound, and the sound output device may include a speaker.

The controller 450 may be implemented by various processing devices, such as a microprocessor with a built-in semiconductor chip configured for performing the operation or the execution of the various commands, and may control the operation of the portable terminal according to an exemplary embodiment of the present disclosure.

According to an exemplary embodiment of the present disclosure, when the input by the user is received, the controller 450 may control information input from the user to be transmitted to the server 300. When being informed, from the server 300, that the charging station is unavailable or that the charging station is available, the controller 450 may output the information received from the server 300 via the output device 440.

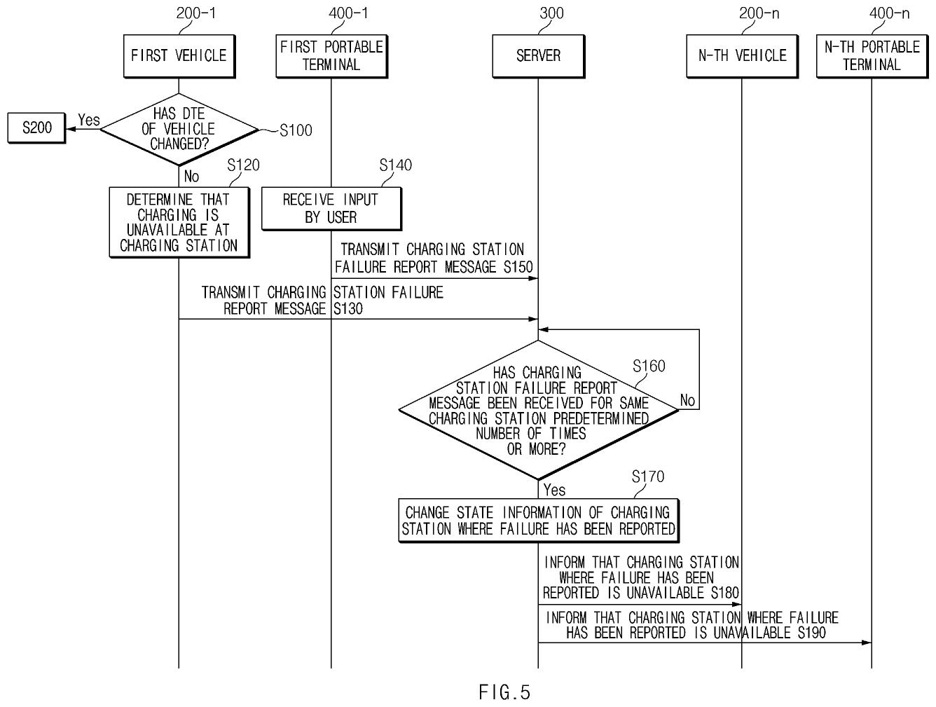

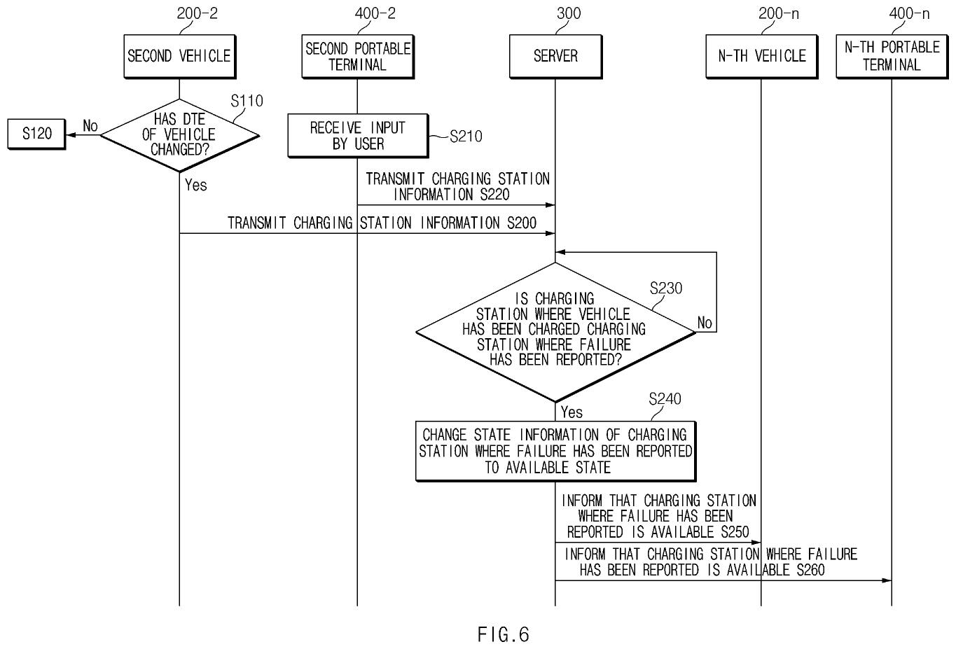

FIG. 5 and FIG. 6 are views exemplarily illustrating a vehicle charging control method according to an exemplary embodiment of the present disclosure.

As shown in FIG. 5, the first vehicle 200-1 may determine the distance to empty (DTE) based on the battery residual amount or the fuel residual amount. The first vehicle 200-1 may determine whether the distance to empty of the vehicle has changed when the charging is performed (S100).

When determining in S100 that the distance to empty has not changed after the charging is performed (No), the first vehicle 200-1 may determine that the charging is unavailable at the charging station (S120).

When determining that the charging is unavailable at the charging station, the first vehicle 200-1 may transmit the charging station failure report message to the server 300 (S130).

On the other hand, when determining that the distance to empty has changed after the charging is performed, the controller 250 performs S200. Amore detailed description will be made with reference to FIG. 6.

A first portable terminal 400-1 may receive the input by the user (S140). According to an exemplary embodiment of the present disclosure, the first portable terminal 400-1 may receive the charging station failure report message indicating that the charging is unavailable at the charging station charging from the user.

When receiving the charging station failure report message from the user, the first portable terminal 400-1 may transmit the charging station failure report message to the server 300 (S150).

When receiving the charging station failure report message from the first vehicle 200-1 and the first portable terminal 400-1, the server 300 may determine whether the charging station failure report message has been received for the same charging station the predetermined number of times or more (S160). In this regard, the predetermined number of times may be set based on the number of vehicles in communication with the server 300. For example, when the number of vehicles in communication with the server 300 is great, the predetermined number of times may be increased, and when the number of vehicles in communication with the server 300 is small, the predetermined number of times may be decreased.

When determining in S160 that the charging station failure report message has been received the predetermined number of times or more (Yes), the server 300 may determine that the plurality of vehicles of the number corresponding to the predetermined number of times have determined that the charging is unavailable at a same charging station, and may change the state information of the charging station where the failure has been reported (S170).

According to an exemplary embodiment of the present disclosure, in S170, when determining that the charging station failure report message has been received the predetermined number of times or more than the predetermined number of times, the server 300 may change the state information of the charging station where the failure has been reported from the available state to the unavailable state.

When the state information of the charging station where the failure has been reported changes from the available state to the unavailable state, the server 300 may inform that the charging station where the failure has been reported is unavailable. According to an exemplary embodiment of the present disclosure, the server 300 may inform the n-th vehicle 200-n except for the vehicle that has transmitted the charging station failure report message that the charging station where the failure has been reported is unavailable (S180), and inform an n-th portable terminal 400-n except for the portable terminal 400 that has transmitted the charging station failure report message that the charging station where the failure has been reported is unavailable (S190).

Although not shown, the n-th vehicle 200-n may output the information received from the server 300 via the output device. Furthermore, the n-th vehicle 200-n may receive the information from the server 300 in real-time to update the route to the destination. Furthermore, the n-th portable terminal 400-n may output the information received from the server 300 via the output device.

In one example, as shown in FIG. 6, the second vehicle 200-2 may determine the distance to empty (DTE) based on the battery residual amount or the fuel residual amount. The first vehicle 200-1 may determine whether the distance to empty of the vehicle has changed when the charging is performed (S110).

When determining in S110 that the distance to empty has changed after the charging is performed (Yes), the second vehicle 200-2 may determine that the charging is available at the charging station.

When determining that the charging is available at the charging station, the second vehicle 200-2 may transmit the charging station information to the server 300 (S200).

On the other hand, when determining in S110 that the distance to empty has not changed after the charging is performed, the controller 250 performs S120 in FIG. 5.

The second portable terminal 400-2 may receive the input by the user (S210). According to an exemplary embodiment of the present disclosure, the second portable terminal 400-2 may receive the charging station information input by the user.

When receiving the charging station information input by the user, the second portable terminal 400-2 may transmit the charging station information to the server 300 (S220).

The server 300 may receive the charging station information from the second vehicle 200-2 or the second portable terminal 400-2. When receiving the charging station information from the second vehicle 200-2 or the second portable terminal 400-2, the server 300 may determine whether the charging station where the vehicle has been charged is the charging station where the failure has been reported based on the received charging station information (S230).

When determining in S230 based on the charging station information received from the second vehicle 200-2 that the charging station where the vehicle has been charged is the charging station where the failure has been reported (Yes), the server 300 may change the state information of the charging station where the failure has been reported (S240).

According to an exemplary embodiment of the present disclosure, in S240, when determining based on the charging station information received from the second vehicle 200-2 that the charging station where the vehicle has been charged is the charging station where the failure has been reported, the server 300 may change the state information of the charging station where the failure has been reported from the unavailable state to the available state.

When the state information of the charging station where the failure has been reported changes from the unavailable state to the available state, the server 300 may inform that the charging station where the failure has been reported is available.

According to an exemplary embodiment of the present disclosure, the server 300 may inform the n-th vehicle 200-n except for the second vehicle 200-2 that has transmitted the charging station information that the charging station where the failure has been reported is available (S250), and inform the n-th portable terminal 400-n except for the second portable terminal 400-2 that has transmitted the charging station information that the charging station where the failure has been reported is available (S260).

Although not shown, the n-th vehicle 200-n may output the information received from the server 300 via the output device. Furthermore, the n-th vehicle 200-n may receive the information from the server 300 in real-time to update the route to the destination. Furthermore, the n-th portable terminal 400-n may output the information received from the server 300 via the output device.

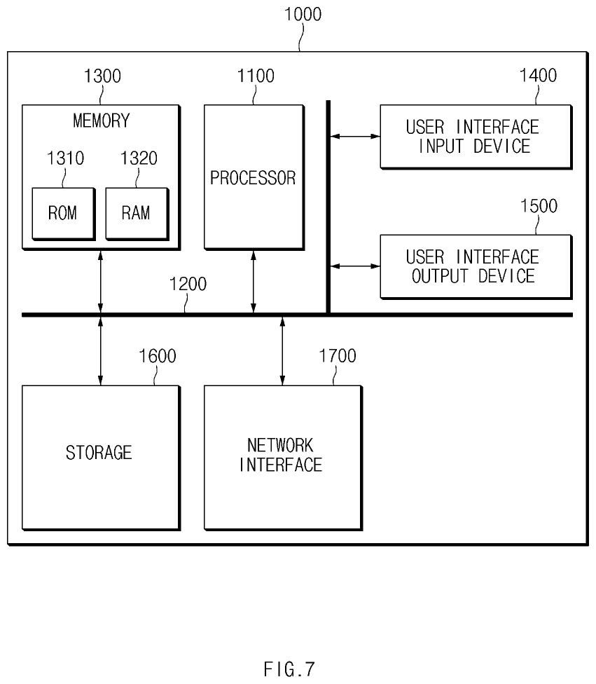

FIG. 7 is a view exemplarily illustrating a configuration of a computing system executing a method according to an exemplary embodiment of the present disclosure.

With reference to FIG. 7, a determining system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the exemplary embodiments included in an exemplary embodiment of the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The system and the method for controlling the charging of the vehicle according to an exemplary embodiment of the present disclosure may provide the stable charging station information to the user by updating the charging station information in real-time.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for controlling charging of a vehicle, the system comprising:
the vehicle configured to:
determine whether a distance to empty (DTE) thereof has changed based on the charging; and
transmit a charging station failure report message upon concluding that there is no change in the distance to empty; and
a server configured to:
receive the charging station failure report message from the vehicle;
change state information of a charging station where a failure has been reported; and
inform that the charging station where the failure has been reported is unavailable.

2. The system of claim 1, wherein the server is configured to change the state information of the charging station where the failure has been reported when the charging station failure report message is received a predetermined number of times or more than the predetermined number of times.

3. The system of claim 1, wherein the server is configured to change the state information of the charging station where the failure has been reported from an available state to an unavailable state when the charging station failure report message is received.

4. The system of claim 1, further including:
a portable terminal for transmitting the charging station failure report message to the server when a user input related to the charging station failure is received.

5. The system of claim 1, wherein the vehicle is configured to transmit charging station information to the server when there is the change in the distance to empty based on the charging.

6. The system of claim 5, wherein the server is configured to determine whether a charging station where the vehicle has been charged is the charging station where the failure has been reported based on the received charging station information.

7. The system of claim 6, wherein the server is configured to change a state of the charging station where the failure has been reported from an unavailable state to an available state when concluding that the charging station where the vehicle has been charged is the charging station where the failure has been reported.

8. The system of claim 1, wherein the server is configured to inform that the charging station where the failure has been reported is available when a state of the charging station where the failure has been reported is changed from an unavailable state to an available state.

9. A method for controlling charging of a vehicle, the method comprising:
determining, by the vehicle, whether a distance to empty thereof has changed based on the charging;
transmitting, by the vehicle, a charging station failure report message to a server upon concluding that there is no change in the distance to empty;
receiving, by the server, the charging station failure report message, and changing state information of a charging station where a failure has been reported, from the vehicle; and
informing, by the server, that the charging station where the failure has been reported is unavailable.

10. The method of claim 9, further including:
changing, by the server, the state information of the charging station where the failure has been reported when the charging station failure report message is received a predetermined number of times or more than the predetermined number of times.

11. The method of claim 9, further including:
changing, by the server, the state information of the charging station where the failure has been reported from an available state to an unavailable state when the charging station failure report message is received.

12. The method of claim 9, further including:
receiving, by the server, the charging station failure report message from a portable terminal.

13. The method of claim 9, further including:
transmitting, by the vehicle, charging station information to the server when there is the change in the distance to empty based on the charging.

14. The method of claim 13, further including:
determining, by the server, whether a charging station where the vehicle has been charged is the charging station where the failure has been reported based on the received charging station information.

15. The method of claim 14, further including:
changing, by the server, a state of the charging station where the failure has been reported from an unavailable state to an available state when concluding that the charging station where the vehicle has been charged is the charging station where the failure has been reported.

16. The method of claim 9, further including:
informing, by the server, that the charging station where the failure has been reported is available when a state of the charging station where the failure has been reported is changed from an unavailable state to an available state.
